(19) United States
(12) Patent Application Publication
(10) Pub. No.: US 2026/0301027 A1
(43) Pub. Date: Oct. 1, 2026

(54) SYSTEM AND METHOD FOR CAPTURING AND EVALUATING CUSTOMER BEHAVIOUR DATA

(71) Applicant: Herbert BOOS, Kelkheim (DE)

(72) Inventor: Herbert BOOS, Kelkheim (DE)

(21) Appl. No.: 18/996,515

(22) PCT Filed: Jul. 25, 2022
(86) PCT No.: PCT/DE2022/000082

§ 371 Date: Jan. 17, 2025

(51) Int. Cl. G06Q 30/0251; G06Q 20/20

(52) U.S. Cl. CPC G06Q 30/0268; G06Q 20/208

(57) ABSTRACT

The invention relates to a system and a method for capturing and evaluating customer behaviour data of customers who are influenced by advertising and/or information in shops, where via hand-held scanners, which can be captured by sensors and are used by the customers when shopping, the customers' routes and times spent in the shop are captured and the purchases are captured chronologically and in a time-accurate manner by the hand-held scanners. At selected places in the shop, output media are arranged via which advertising messages are output in audiovisual or another form in a controlled manner. A data processing system is used to control the output of the advertising messages and to store and evaluate the data captured via the hand-held scanners and the sensors. Via further sensors, fringe condition data such as the outdoor temperature, indoor temperature, air humidity or air pressure can be captured.

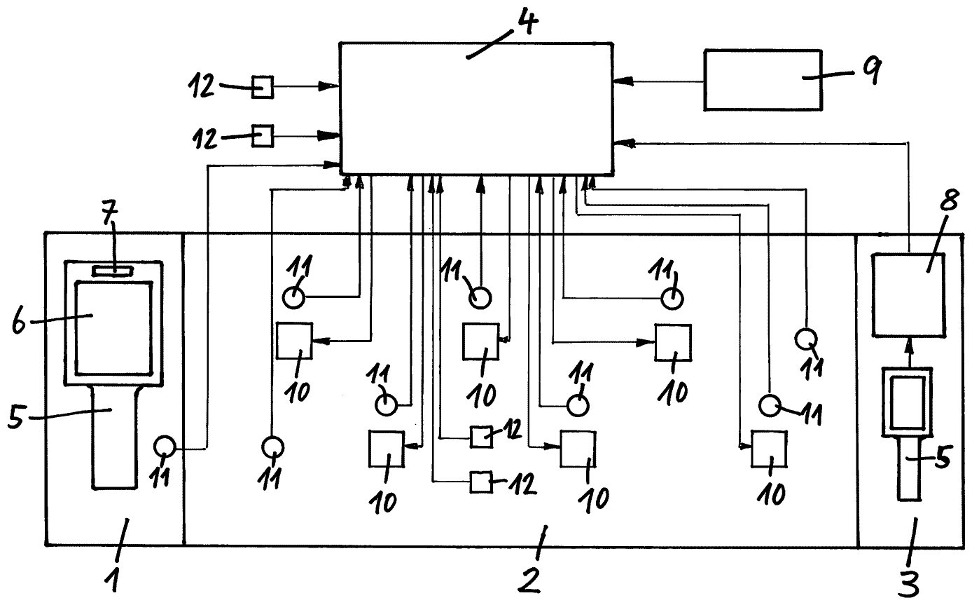

The invention relates to a system and method for anonymously capturing and analysing customer behaviour data of customers who are influenced by advertising and/or information in supermarkets, DIY stores and other sales outlets.

Retailers always seek to promote sales by addressing customers as specifically as possible and by advertising products as precisely targeted as possible and placing them in the focus of the customer's attention.

From EP 2 806 390A1, there is known a method and device for controlling the output of product-related advertising messages to customers in sales facilities, the method and device correlating advertising measures in supermarkets and customer behaviour, the goal being to opti-mise the advertising approach to customers.

Shopping carts and shopping baskets are provided with a technically readable, preferably electronically scannable identifier, which enables capturing the shopping cart or shopping basket at the supermarket entrance area, at selected locations within the supermarket and at the check-out, and assigning it to a specific customer, who nevertheless remains anonymous, as well as tracking the customer's path through the supermarket, and also to capture their dwelling time at certain locations and correlate it with product advertising, which is preferably visually displayed at these locations. In the checkout area, purchases made by the respective customer are assigned to the customer, who remains anonymous, based on the identifier of the shopping cart or shopping basket. In addition, general shopping conditions, such as the day of the week, time, weather conditions, outside temperature, temperature in the supermarket or humidity, are captured and assigned to the purchases made by the respective customer, so as to be able not just to estimate the likely influence of product advertising at various locations in the supermarket for specific products in each case, but also to correlate the respective customer's purchases with the prevailing general conditions and to establish customer behaviour and advertising success more precisely over a longer period of time by capturing, storing and analysing this data using a data processing system.

The object of the present invention is to provide a system and method that allows for even more precise and informative capturing of customer behaviour and of the influence of advertising on the customer.

This object is achieved by the system according to claim 1 and the method according to claim 6. Similar to the above-described system known from EP 2 806 390 A1, the system and method of the invention uses a central data processing system, and output media for visual and/or audio advertising messages arranged at specific locations within the sales outlet.

The central data processing system is used for storing, correlating and analysing data on prevailing general conditions and sales data, as described above in connection with the system known from EP 2 806 390 A1, and also has a memory and a control device for storing and programmably outputting product-related advertising messages and/or general advertising messages to the respective output media arranged in the sales outlet, which may be screens, displays, interactive screen devices or audio devices and may be arranged in or on shelves, suspended from the ceiling, or integrated in display stands, advertising columns or the like.

In addition, there are sensors distributed throughout the sales outlet, which are each assigned to specific areas of the sales outlet, such as the entrance area, checkout area and respective product areas, and which are connected to the central data processing system and serve to capture the presence of customers. In the known system, the sensors are used to detect and capture shopping carts or shopping baskets located in their reception area, which are provided with appropriate technically readable identification elements such as transponders used for temporary individualised identification of customers using these shopping carts or baskets during shopping.

The system and method according to the invention employs handheld scanners, which the customer uses while shopping. The customer receives a handheld scanner provided by the sales outlet at the entrance and carries it with them during shopping, so that they can scan each item picked up from a shelf for purchase. The customer can then place the scanned item in a shopping cart or basket, or even in a bag they brought with them, as the data from the handheld scanner is transferred directly to the checkout and the customer only has to pay.

Such handheld scanners are known per se and are in use. They have a display to show the customer product information such as the article name and/or article number of the scanned product and its price, and which can also display the number, unit prices and the total amount of products purchased by the customer during their visit.

According to the invention, these handheld scanners are additionally provided with an integrated, technically readable identification element, such as an RFID transponder, which can be detected and read by the sensors within the sales outlet.

Thus, in the system and method according to the invention, the respective handheld scanner is also used to anonymously individualise the customer using it, at least temporarily for the duration of shopping, so shopping carts and/or shopping baskets do not have to be equipped with such identification elements.

Since the handheld scanners are marked with a technically readable identification element, the respective presence of the handheld scanner and thus of the customer using it can be captured via the sensors in the sales outlet and reported to the central data processing system, which records and stores the presence of the handheld scanner at the corresponding location of the sales outlet together with the time and dwelling duration.

In this way, a customer's path within the sales outlet can be tracked from the point of entry to the checkout, which is unobjectionable under data protection law, so that it is not only possible to trace exactly, in compliance with data protection law, which paths through the sales outlet the customer in question has taken and which product areas they have passed by, but also at which locations within the sales outlet the customer spent what amount of time, thus showing interest in the products there, especially at locations where a particular product was advertised via a display medium located there, and how long the customer may have stayed there. This also makes it possible to trace that, and at what time, a customer may have taken notice of a certain advertising message at that location.

The handheld scanners are programmed and configured to provide with a time stamp and store each scan of an appropriately coded tag or of a product the customer has picked up from a shelf for purchase. If the customer reverses a purchase by putting the item back on the shelf and can-celling the purchase on the scanner, the scanner also provides this input with a time stamp.

When, at the end of the customer's shopping, the purchase data is transferred, in the checkout area, from the respective handheld scanner to a reader unit and stored in the central data processing system, it is therefore not only known what exactly the customer has purchased, but also, for each item, when the purchase was made or cancelled.

This data can be correlated in the central data processing system with the reporting data from the sensors, which indicates at what time the customer in question was at which location within the sales outlet. Because the central data processing system also registers which advertising message for which product was displayed at which time and at which location of the sales outlet, the system can, by correlation with this data, trace the purchasing behaviour of the respective customer with considerably greater precision and informative value and thus also assess the effectiveness of the product advertising much more accurately than was possible with the known system described at the outset, because now the exact sequence and/or the exact time of product purchases, for example, can also be correlated for the first time with the advertising messages and/or information displayed and/or areas of the sales outlet.

This is because the analysis of the correlated data shows whether a customer had already purchased a certain product before they could have perceived product advertisement for it, or whether they purchased the respective product only afterwards, and at what time, in which latter case the system can even determine a probability of the advertisement having or not having influenced the customer's purchase.

Based on the analysis of this data, it is also possible for the first time in supermarkets, DIY stores and other sales outlets to precisely trace whether, for example, a customer purchased a certain type of product at first but then, because of an advertisement for a different but similar product, replaced the product initially purchased with the advertised product. It can also be traced whether a customer perceived a certain product advertisement because they spent time at the relevant place in the sales outlet and, though they did not initially purchase the product, later returned to the location and purchased the advertised product after all. The extent to which an advertisement for product A (e.g., Pepsi Cola) has influenced not only the sale of product A, but also the sale of a product B of the same category (e.g., Coca Cola) or a product C of a different category (e.g., potato chips) can also now be precisely established for the first time.

In addition to advertising specific products at the respective point of sale of the advertised products, the display media can also be used to draw customers' attention to current promotions, directing them to the respective promotion points at the sales outlet; and in that case too, it can be traced whether a customer has reacted to such promotional advertising by going to the relevant promotion point afterwards.

Moreover, behavioural couponing can be implemented immediately. For example, if a special discount is granted on a specific advertised product as part of a promotion, there is no need to hand out or put out paper coupons for customers to take, which then conventionally are taken into account at the checkout. Instead, all that is needed is a code presented on the output media or scanned at the respective point of sale using the handheld scanner, which code can be generated based on behaviour. Thus, not only can the scannable coupon be taken into account immediately or within a short period at the time of purchase, but the system can also associate with the coupon individual rules and identifiers (e.g., “coupon for customer X only valid from 4 p.m.”, “coupon for customer Y only valid with additional purchase of . . . ”, “coupon for customer Z only valid from a purchased quantity of 3 packs”, etc.) and can still detect or establish whether the customer in question has taken advantage of the coupon-based offer. In addition, the handheld scanner can accept a code individually generated on the system's output media and present it on its own display, so that this code in turn can then be accepted and processed by the handheld scanner's display at any time during shopping from a reading-enabled device, to trigger individual actions either on the system's output media or even on other devices (e.g., cell phones), for example, to automatically access certain websites on the Internet, where customised offers, recipes, product information, etc. are then accessible or can be called up.

It is also possible to enable direct interaction with the customer using special advertising films played on the output media and using QR codes that appear in the films and can be scanned with the handheld scanner. This also makes it possible to precisely identify the respective output medium, including its location, which has output the advertising message and/or information.

Finally, based on the correlated data and because the time for each scan of a purchased product and the presence at certain locations in the sales outlet is recorded, the system can also detect whether, for example, the customer was in a hurry and made hasty purchases, or whether they took their time.

In all of this, the customer remains completely anonymous, while a very precise analysis of customer behaviour is still possible because each purchase and each presence at the various locations within the sales outlet are captured with their precise time, because of the exact sequence of purchases and changes to purchases being captured, and because of the ability to establish follow-up purchases and cancellations.

If sales outlets issue customer cards, a customer entering the sales outlet can first scan their customer card with the handheld scanner, thus identifying themselves as a specific customer. Even if the sales outlet registers the customer with their personal data when issuing a customer card, the customer's anonymity can be preserved if the number of an issued customer card does not match the customer number assigned to the customer and is not registered with the personal data, or if the system encrypts the customer card number, for example. Nevertheless, the customer remains clearly identified to the system based on the customer card or its individual identifier. This has the advantage that the system can identify the returning customer and thus analyse their customer behaviour not only based on a single shopping visit, but on multiple visits.

The invention will be described in more detail below using an exemplary embodiment and with reference to the attached schematic drawing. The drawing depicts the system according to the invention as a block diagram, and the sequence of the method according to the invention as a flow chart.

The drawing shows four main blocks 1-4; namely, an entrance or check-in area 1 of a sales outlet such as a supermarket or DIY store, a sales area 2 of the sales outlet, which may be the sales room or a totality of several sales rooms, a check-out area 3, and a data processing area formed by a central data processing system 4.

Functionally, block 1 embodies the individualisation area for customer individualisation; block 2 embodies the sales room, which is the promotional area for addressing customers and at the same time the reaction area for customers making their purchases; block 3 embodies the verification area for assigning customer verification, and block 4 embodies the area for capturing, recording, storing, enriching and processing data and for controlling the output of advertising messages.

Blocks 1 to 3 are typically areas of a sales outlet, such as a supermarket, department store, DIY store or other market. Block 4, i.e., the data processing area, may be associated with a single sales outlet exclusively, especially if it is a large store, but can also be associated with a number of sales outlets, such as a chain of stores.

In the entrance area 1, through which a customer enters the sales outlet and can take a shopping cart or shopping basket (not shown) if required, the customer also receives a handheld scanner 5, which has a display 6 and is provided with a technically readable identification element such as an RIFD chip 7 that identifies and individualises, for the system according to the invention, the respective handheld scanner and thus also the customer using it, at least during shopping.

If the customer has a customer card, the customer can identify themselves by scanning the customer card with the handheld scanner 5 but still remain anonymous, as explained above.

The customer uses the handheld scanner 5 to scan each product picked up for purchase from a sales shelf or other holding area in the sales outlet, or to scan appropriately coded signage, the scanner providing each scan with a time stamp and storing it with the time stamp so that the scanner registers each purchased product together with the exact time of purchase. During each scan, the display 6 can show the customer the scanned product together with the price and any other product information where applicable. Additionally, during shopping, the display 6 can show the customer the total sum of the purchase prices of all items purchased so far.

In the checkout area 3, the data registered by the handheld scanner 5 is then transmitted to a cash register 8 and from there to the central data processing system 4, where this data is stored and analysed.

The central data processing system 4 also controls the output of advertising messages, which can be retrieved from an archive 9 of advertising messages that may be kept available externally or may be integrated into the data processing system 4. These advertising messages, which may be product related and may serve to advertise a specific product in each case, or which may also contain references to current promotions or other advertising messages, are transmitted by the data processing system 4 to output media 10 which are arranged at specific selected locations in the sales room 2 where advertising messages are to be output, in particular for advertising a specific product offered at the respective location of the sales room 2.

The output media 10 may be screens for presenting visual and/or audiovisual advertising messages and may be positioned in or on sales shelves, integrated into advertising columns or sales stands, or may be suspended from the ceiling of the sales room. Such output media 10 may also at least in part be simply designed as audio devices.

Under the control of the data processing system 4, each output medium is individually provided, e.ge., in parallel or in a multiplex process, with an advertising message to be presented to the customers at the respective point of sale within the sales room 2.

In the area of each output medium 10 there is a sensor 11 which, when a customer with their handheld scanner 5 is in its detection area, reads the identification element 7 of the respective handheld scanner and thus captures the presence of the customer using it and transmits it to the data processing system 4, which registers this capture together with the time of capture. In this way, the presence of each customer within the area of the respective output medium can be captured and registered with its precise time.

In addition, such sensors 11 may also be arranged at other locations within the sales room 2 where it is desirable to register the presence or passing of a customer so that their path through the sales room 2 can be traced. Such a sensor 11 is also arranged in the entrance area 1 in order to capture and register that a customer enters the sales room 2.

Furthermore, sensors 12 are provided both in the outside area and the inside area of the sales room to detect general conditions such as outdoor temperature, air pressure, sales-room indoor temperature or humidity and transmit them to the data processing system 4 for registration.

The capturing and analysing, carried out by the system according to the invention, of data relating to the purchases made by a specific customer with their exact sequence, whereby follow-up purchases and/or cancellations can also be detected, in connection with the captured data relating to purchases made, and in connection with general conditions such as the time of day, temperature, air pressure and humidity conditions, makes it possible to very precisely analyse the customer's behaviour under such general conditions and to correlate it with the advertising messages presented, from which the success or failure of advertising measures and/or advertised products can be assessed quite accurately, and which allows for targeted control of the output of advertising messages in order to target customers with advertising for specific products specifically when, based on the given general conditions, customers will presumably be particularly responsive to certain product advertising. This is the case, for example, when ice cream or soft drinks are advertised in hot temperatures, barbecue products are advertised at weekends in the summer months, rain protection products are advertised during continuous rain, or trend products are advertised depending on customers' purchasing behaviour.

The above description of the system according to the invention also describes the method according to the invention, which comprises individualising or identifying a customer who enters the sales outlet, via the handheld scanner 5 used by the customer, the method further comprising capturing the customer's shopping behaviour by capturing and recording, via the sensors 11, the customer's path through the sales room 2 including dwelling times at certain locations, and registering the purchases made, including any changes thereto, chronologically via the scans with the handheld scanner 5, and preferably capturing and registering the prevailing general conditions in each case via the sensors 11.

Finally, the method comprises storing, correlating and analysing all of this data in the data processing system 4 and controlling the output of advertising messages based on this.

1.-10. (canceled)

11. A system for capturing and analysing customer behaviour data of customers influenced by advertising and/or information in supermarkets, DIY stores and other sales outlets, the system comprising:
handheld scanners made available at the entrance area of the sales outlet for the customer to pick up and use during shopping, and for the customer to scan items picked up for purchase within the sales outlet,
wherein the handheld scanners are each provided with a display to show the customer information such as the price or type of items purchased, and the handheld scanners store the scanned purchases with a time stamp, wherein each handheld scanner is provided with an electronically detectable and readable identification device, such as an RFID chip, in order to provide the handheld scanner with an individual identification,
a checkout where the purchases stored in the handheld scanner are read out,
further, display media arranged at selected locations within the sales outlet for visual, audiovisual or other display of advertising messages, further, sensors which are arranged at selected locations within the sales outlet, particularly at the locations of the output media, and which capture the identification of a handheld scanner entering their detection range, and
a data processing system which controls the output media to output specific advertising messages in each case, which stores the purchases made by a customer that are read out at the checkout, together with the time stamps and with the identification of the handheld scanner, and which stores the presence of a handheld scanner captured by the sensors together with its identification and a time stamp, and which analyses and correlates the data in order to analyse the customer behaviour and optimize control of the output of advertising messages.

12. The system of claim 11, further including further sensors in the indoor area and/or outdoor area of the sales outlet, which are used to capture general conditions such as outdoor temperature, air pressure, humidity or indoor temperature in the sales room and to transmit them to the data processing system for storage together with the respective time.

13. The system of claim 11, wherein the data processing system records a customer's path through the sales outlet based on the data transmitted by the sensors and also records the dwelling times at the locations of the respective sensors.

14. The system of claim 11, wherein the handheld scanners are configured and programmed to enable communication between individual output media and the handheld scanner by scanning QR codes or coupons, and for generating a corresponding indication on the display.

15. The system of claim 11, wherein the handheld scanners are configured to scan a customer card of the customer and capture, for example, a card number without any personal data of the customer, which is stored with the customer's purchases in the data processing system to anonymously distinguish the customer from other customers.

16. A method for capturing and analysing customer behaviour data of customers influenced by advertising and/or information in supermarkets, DIY stores and other sales outlets, the method comprising:
providing handheld scanners with an individual, electronically readable identification,
making the handheld scanners available at the entrance area of the sales outlet for customers to pick up and use while shopping, and for the customers to scan items picked up for purchase within the sales outlet,
storing each purchase transaction together with a time stamp using the handheld scanner,
reading out, from the handheld scanners, the purchases with the time stamps and the identifications of the handheld scanners at a checkout,
arranging output media at selected locations within the sales outlet, and controlled output of advertising messages and/or information by the output media, the type and time of the advertising messages output by each output medium being stored,
arranging sensors at selected locations within the sales outlet, and capturing handheld scanners entering a detection range of the sensors based on their identification, and storing the presence of a handheld scanner within the range of a sensor together with the identification of the handheld scanner and the capture time, and
analysing and correlating the collected and stored data to assess customer behaviour and modify the output of the advertising messages accordingly.

17. The method of claim 16, further comprising:
arranging further sensors in the outdoor area and/or indoor area of the sales outlet, capturing general conditions such as outdoor temperature, air pressure, humidity or indoor temperature in the sales room, and conveying this general-condition data to a storage location.

18. The method of claim 16, further comprising determining and recording the paths taken by the customers within the sales outlet based on the sensors capturing the presence of the handheld scanners.

19. The method of claim 16, further comprising configuring and programming the handheld scanners for communication with output media to capture QR codes displayed by output media or coupons, and for generating a corresponding indication on the display of the handheld scanner.

20. The method of claim 16, further comprising programming the handheld scanners to enable the handheld scanners to scan a customer card of the customer and capture, for example, a card number without any personal data of the customer to anonymously distinguish the customer from other customers, and to store this card number or the like together with the customer's purchases.
